(19) United States
(12) Patent Application Publication
(10) Pub. No.: US 2002/0163410 A1
(43) Pub. Date: Nov. 7, 2002

(54) Two-part solenoid and method for the production thereof

(76) Inventors: Waldemar Hans, Bamberg (DE); Mathias Linssen, Litzendorf (DE); Christof Vogel, Bischberg (DE); Helmut Hennemann, Schesslitz (DE)

Correspondence Address: KENYON & KENYON, ONE BROADWAY, NEW YORK, NY, 10004, US

(21) Appl. No.: 10/049,805

(22) PCT Filed: Jun. 8, 2001
(86) PCT No.: PCT/DE01/02147

(30) Foreign Application Priority Data
Jun. 14, 2000 (DE) 100 29 279.8

(51) Int. Cl. H01F 7/08

(52) U.S. Cl. 335/220

(57) ABSTRACT

A solenoid (2) including a largely cylindrical hollow bobbin (3) made of an insulating material which is mountable on a housing body (18) and is provided with at least two relay connectors (1) anchored in an end area (4) of the bobbin (3) and projecting axially therefrom, with the solenoid also including a contact element (9). The solenoid (2) and the contact element (9) are two separate components which are connectable to each other by a connecting part (16) of the contact element (9) attachable to the housing body (18) and by bonding (20).

### BACKGROUND INFORMATION

The present invention is based on a two-part solenoid according to the definition of the species in claim 1, and a method for the manufacture thereof according to the definition of the species in claim 14.

A solenoid as recited in the preamble of claim 1 is already known from German Patent 295 14 315 U1. The solenoid includes a largely cylindrical hollow bobbin made of an insulating material that is provided with two relay connectors anchored in an end area of the bobbin and projecting axially therefrom, with it being possible to wind the bobbin mechanically: The bottom of the bobbin forming the bottom of the winding space has variable adjacent winding levels in the axial direction which are offset against one another in the radial direction, with the transitions between the winding levels being designed as a bevel having an inclination of approximately 30 degrees. Except in the transition areas, the bottom of the bobbin is provided with grooves for the winding wire.

The disadvantage of the solenoid known from German Patent 295 14 315 U1 lies, in particular, in the overall length of the solenoid, which is determined by the length of the relay connector. This makes the solenoid susceptible to damage, for example, when mechanically winding the coil wire. The relay connectors have a tendency to bend.

Another disadvantage is that different flat connectors for the electrical lines may require different manufacturing methods, which complicates the production process and makes it expensive.

### SUMMARY OF THE INVENTION

The solenoid according to the present invention having the features of claim 1, and the method according to the present invention for the manufacture of a solenoid, having the features of claim 14, have the advantage over the related art that the short relay connectors enable the solenoid to be easily handled in subsequent processing steps, and, in addition, a contact element of any shape, for example a flat connector, may be attached to the solenoid by a simple snap-on connection and subsequently soldered to the relay connectors.

The features described in the subordinate claims represent advantageous embodiments of the solenoid indicated in claim 1 and the method indicated in claim 14.

One particular advantage is the easy manufacture of the relay connectors and contact elements, which may be manufactured, for example, by punching them out of a metal sheet.

The connecting part between the solenoid and the contact element is advantageously made of a flexible plastic which enables the contact element to be mounted on the bobbin or the valve housing.

The contact tabs of the contact element are still connected during manufacturing, which makes it easier to correctly position the contact tabs relative to each other. After being extrusion-coated with plastic, the contact tabs are separated by punching.

The angled extensions of the contact tabs give the contact element a shape that allows it to be easily connected to the relay connectors.

### DRAWING

An exemplary embodiment of the present invention is illustrated in simplified form in the drawing and explained in greater detail in the description below, where:

FIG. 1A shows a schematic top view of a relay connector of a solenoid according to the present invention,

FIG. 1B shows a schematic side view of a relay connector of a solenoid according to the present invention,

FIG. 1C shows a schematic section along the line of intersection marked IC-IC in FIG. 1A,

FIG. 2A shows a schematic view of the bobbin of a solenoid according to the present invention,

FIG. 2B shows a schematic longitudinal section of the bobbin of a solenoid according to the present invention,

FIG. 2C shows a detail of area IIC from FIG. 2B,

FIG. 3A shows a schematic cross-section of a solenoid according to the present invention,

FIG. 3B shows a schematic side view according to FIG. 3A,

FIGS. 4A-C show a schematic view of the contact element of the solenoid according to the present invention in three consecutive stages of processing, and

FIGS. 5A-E show a schematic representation of the method steps according to the present invention for connecting the solenoid to the contact element.

### DESCRIPTION OF THE EXEMPLARY EMBODIMENT

Solenoid 2 according to the present invention is suitable, in particular, as a component for a fuel-injection valve like those used, for example, to inject fuel into the combustion chamber of a mixture-compressing, internal combustion engine with externally supplied ignition.

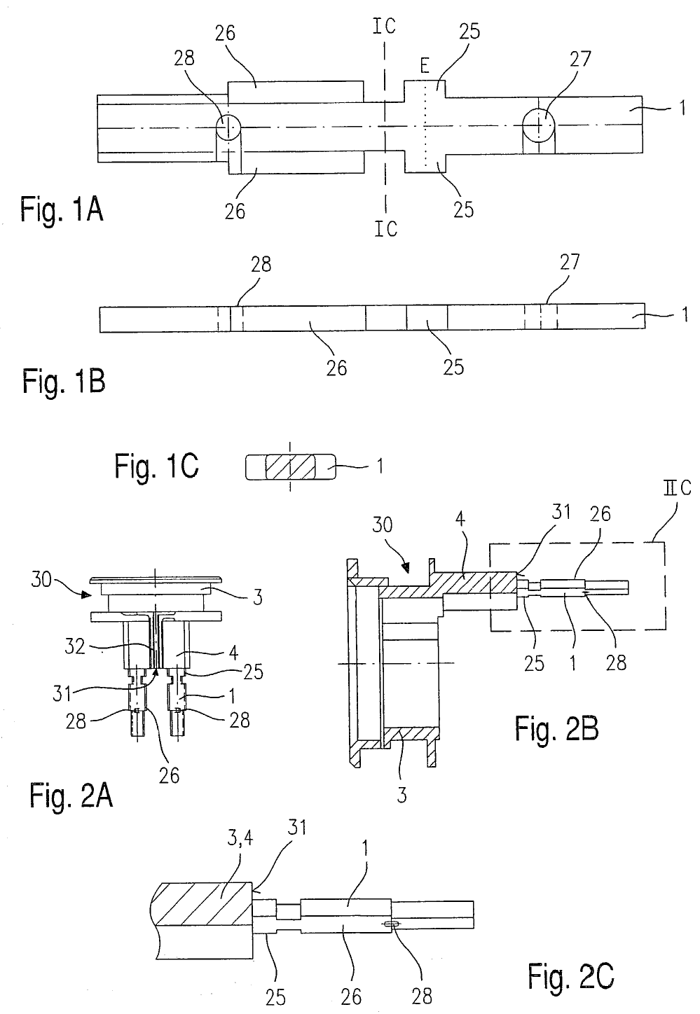

FIGS. 1A-1C show a schematic representation of a relay connector 1 of a solenoid 2 according to the present invention in different views.

FIG. 1A shows a top view of relay connector 1, which is needed to suitably hold in place wire ends 7 of wire 6 which is wound to form solenoid 2, so that the ends may be connected to electrical lines leading to a control unit for the fuel injection valve.

Relay connector 1 has a generally tab-like shape having side projections 25 and 26. Shorter projections 25 are used, in particular, to stabilize the position of relay connector 1 in a bobbin 3.

Projections 26 are used to widen the surface of relay connector 1 so that, after bobbin 3 has been wound, the ends of winding 5 can be attached to relay connector 1, for example by soldering.

Relay connector 1 also has holes 27 and 28, which, like projections 25 and 26, are used to fix relay connector 1 in place in bobbin 3 or to fasten wire ends 7. For example, wire ends 7 may be fed through hole 28 and then pinched. Hole 27 is filled with plastic when relay connector 1 is injected into bobbin 3, thereby securing relay connector 1 in place in bobbin 3.

FIG. 1B shows a corresponding side view of relay connector 1. Due to its simple shape, relay connector 1 may be easily produced, for example, by punching it out of a metal sheet.

FIG. 1C shows a cross-section along the line marked IC-IC in FIG. 1A. As in the present exemplary embodiment, relay connector 1 may have rounded edges, which further simplifies processing.

FIGS. 2A-2C show a schematic view and a schematic longitudinal section of bobbin 3 of a solenoid 1 according to the present invention as well as a detail of the area marked IIC in FIG. 2B.

FIG. 2A shows a schematic side view of unwound bobbin 3 having relay connectors 1 already attached to bobbin 3. Because of their simple shape, relay connectors 1 are easily connectable to bobbin 3. Bobbin 3 is principally made of plastic by injection molding. Relay connector 1 is injected into bobbin 3 up to lateral projections 25.

Bobbin 3 has a largely cylindrical hollow design with a circumferential recess 30 for holding winding 5.

An extension 4 of bobbin 3, which forms an end area and extends the cylindrical hollow cross-section of bobbin 3 in an angular range of approximately 40°, is molded onto bobbin 3. Relay connectors 1 are injected in one end area 31 of extension 4.

FIG. 2B shows a longitudinal section of bobbin 3 of solenoid 2 according to the present invention, illustrated in a schematic sectional representation. Relay connectors 1 are attached in projecting end area 31 of extension 4 of bobbin 3.

FIG. 2C shows an enlarged section of FIG. 2B in area IIC for further clarification. Relay connectors 1 are inserted into extension 4 of bobbin 3 up to the point marked E in FIG. 1A.

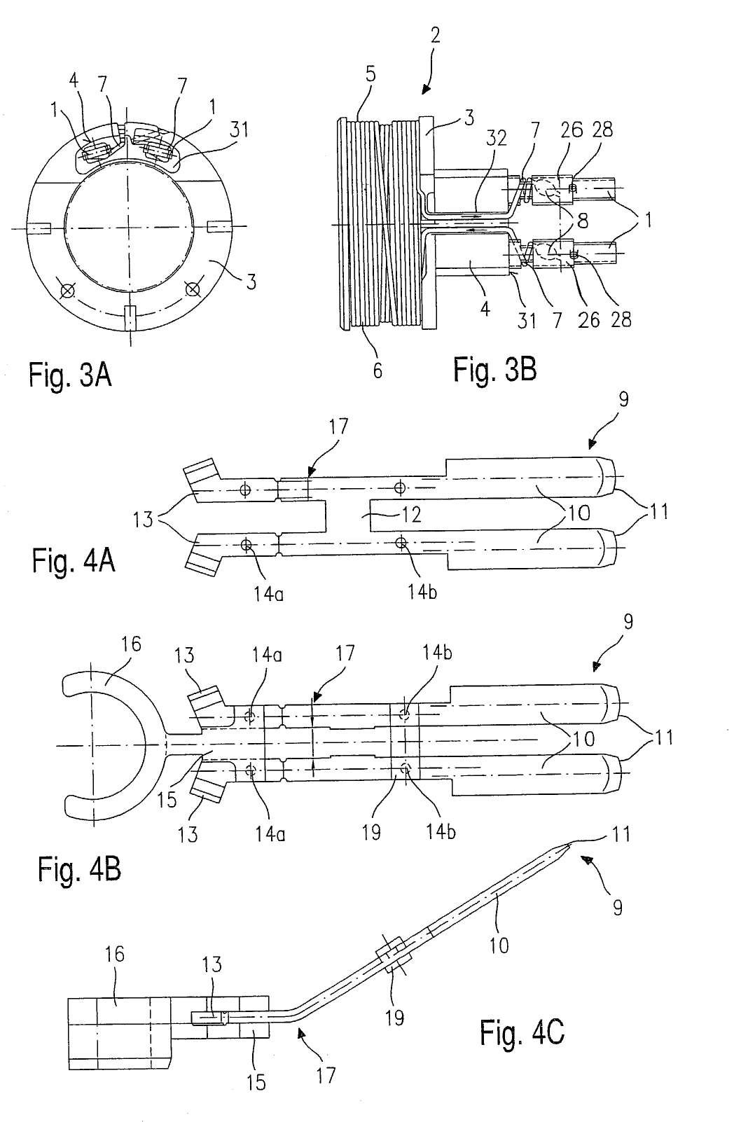

FIG. 3A shows a view of the relay connector end of a solenoid 2 according to the present invention. Of a winding 5 of solenoid 2, only wire ends 7, which are wound around relay connector 1, are visible.

FIG. 3B shows a side view of a solenoid 2 according to the present invention, around which winding 5 of a wire 6 is wound on bobbin 3. Wire ends 7 are routed from winding 5 of solenoid 2 via extension 4 of bobbin 3 to relay connectors 1. Wire ends 7 are routed to relay connectors 1 in an indentation 32 provided in extension 4 of bobbin 3, and they are wound around relay connectors 1 at least once in the area between projections 25 and 26 and may have flattened segments 8 for better attachment to relay connectors 1. Possible attachment methods include welding or soldering or even fixing wire ends 7 in hole 27.

FIGS. 4A-4C show schematic representations of three consecutive processing steps in the manufacture of a contact element 9 according to the present invention.

FIG. 4A shows a schematic view of one exemplary embodiment of contact element 9, which, like relay connectors 1, is easily punchable from a metal sheet. Contact element 9 has two contact tabs 10 which have rounded front edges 11. Both contact tabs 10 are punched out in a single piece, connected by a web 12 which is removed later on. Two extensions 13 projecting outward at any angle are provided at the end of contact element 9 opposite rounded edges 11. Extensions 13 are used for connection to relay connectors 1 in a later processing step. Multiple holes 14a, 14b are provided in contact tabs 10 of contact element 9, with the present exemplary embodiment having two holes per contact tab 10.

In the next processing step, whereby contact element 9 is extrusion-coated, the plastic enters holes 14a, 14b, securely anchoring contact tabs 10 of contact element 9 in the plastic.

FIG. 4B shows a schematic view of contact element 9 after contact tabs 10 have been extrusion-coated with plastic. A first plastic web 15 is formed in the area of holes 14a. The plastic enters holes 14a and holds contact tabs 10 a certain distance apart, determined by the width of web 12. A connecting part 16 according to the present invention is injection-molded onto plastic web 15. For stability, a second plastic web 19 is provided in the area of holes 14b and used to stabilize the position of contact tabs 10 relative to one another.

To electrically isolate contact tabs 10, metallic web 12 is removed by punching.

First plastic web 15 continues into connecting part 16, which was injection-molded onto contact element 9, using a suitable apparatus which is not illustrated in any further detail here. Connecting part 16 is in the shape of a hollow cylinder that is open at one end. Slightly more than half of the cylinder wall is designed as a complete hollow cylinder. Extensions 13, which will connect contact tabs 10 to relay connectors 1 later on, project laterally from plastic web 15.

FIG. 4C shows a side view of the exemplary embodiment of contact element 9 illustrated in FIG. 4B after a further processing step. In this processing step, contact element 9 is bent at an approximately 30-degree angle toward the horizontal at a bending point 17 in the vicinity of plastic web 15.

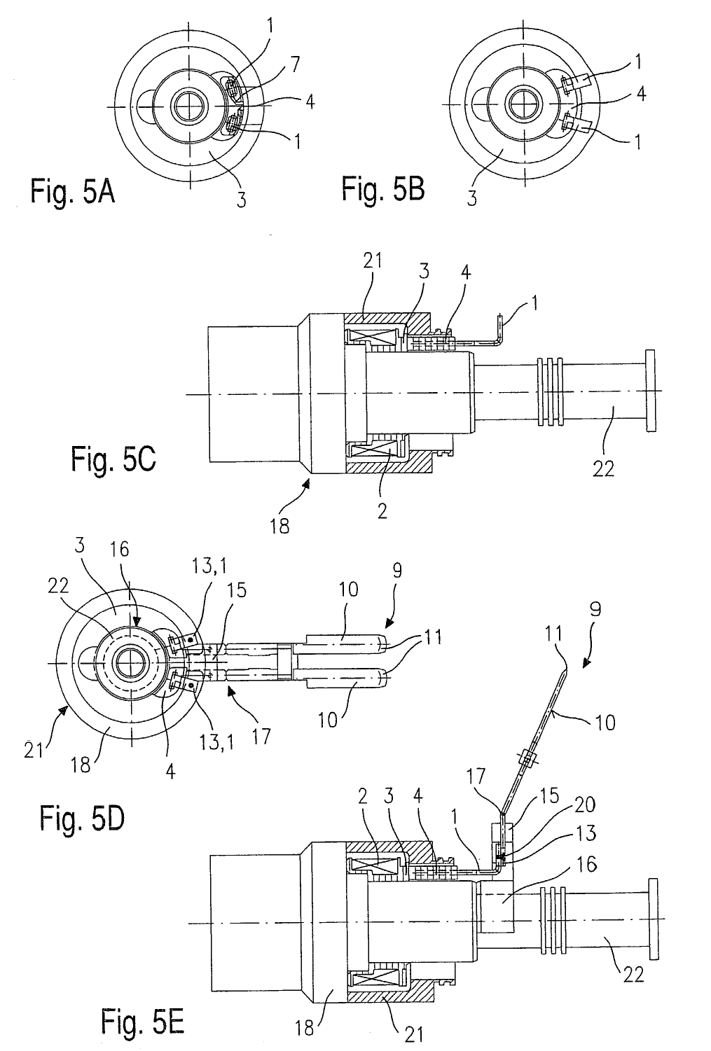

FIGS. 5A-5E show a schematic representation of the method steps for connecting solenoid 2 according to the present invention to contact element 9. FIG. 5A shows a view similar to that in FIG. 3A of the relay connector end of bobbin 3. Relay connectors 1 and wire ends 7 are visible in end area 4 of bobbin 3.

FIG. 5B shows the same representation of bobbin 3 after relay connectors 1 have been bent. Relay connectors 1 are preferably bent outward at a 90-degree angle from their previous position.

FIG. 5C shows a side view of solenoid 2 that is already mounted on a housing body 18. Housing body 18 has an external housing 21, which encapsulates solenoid 2, and an inner housing part 22 that grips solenoid 2 and has an outer diameter equal to the inner diameter of connecting part 16. Due to the special shape of connecting part 16 according to the present invention, it may be mounted on inner housing part 22 in a stable snap-on connection. Connecting part 16 surrounds inner housing part 22 in an area which forms an angle greater than 180 degrees, preventing connecting part 16 from sliding off inner housing part 22 in the radial direction.

FIG. 5D shows the same view as FIGS. 5A and 5B, illustrating bobbin 3, which is mounted on inner housing part 22, with connecting element 9 positioned over connecting part 16. Extensions 13 of contact tabs 10 of contact element 9 come to rest on bent relay connectors 1 of bobbin 3. First plastic web 15 of contact tabs 10 of contact element 9 has an external shape that prevents connecting part 16 from sliding on internal housing part 22.

In the final method step, as shown in FIG. 5E, contact element 9 is connected to relay connectors 1 by a weld 20 or by soldering it onto extensions 13. The welding or soldering step arrests contact element 9 firmly in its final position so that it cannot move in either an axial or radial direction. This also establishes a secure electrical contact between contact element 9 and relay connectors 1.

The present invention is not limited to the illustrated exemplary embodiment, but is also suitable for a contact element 9 having a wide variety of other shapes. According to the method, coils having multiple windings insulated against one another may be provided with a contact element of any design.

What is claimed is:

1. A solenoid (2) having a largely cylindrical hollow bobbin (3) which is made of an insulating material, may be slid onto a housing body (18) and is provided with at least two relay connectors (1) anchored in an end area (4) of the bobbin (3) and projecting axially therefrom; and having a contact element (9), wherein the solenoid (2) and the contact element (9) are two separate components, which are connectable to each other by a connecting part (16) of the contact element (9) attachable to the housing body (18), and by bonding (20).

2. The solenoid according to claim 1, wherein the contact element (9) has at least two extensions (13) that are connectable by the bond (20) to the relay connectors (1) of the solenoid (2).

3. The solenoid according to claim 1 or 2, wherein the bond (20) is preferably formed by welding or soldering.

4. The solenoid according to one claims 1 through 3, wherein the contact element (9) has at least two contact tabs (10) which are connected to each other by a web (12).

5. The solenoid according to claim 4, wherein the contact tabs (10) have holes (14a, 14b).

6. The solenoid according to claim 4 or 5, wherein the contact element (9) is connected to the connecting part (16) by a first plastic web (15), the first plastic web (15) extending between the contact tabs (10), and each of the holes (14a) located in the contact tabs (10) being embedded in the first plastic web (15).

7. The solenoid according to claim 6, wherein two further holes (14b) are connected to each other by a second plastic web (19) which extends between the contact tabs (10).

8. The solenoid according to one of claims 1 through 7, wherein the connecting part (16) partially surrounds the housing body (18).

9. The solenoid according to claim 8, wherein the housing body (18) is cylindrical in shape.

10. The solenoid according to claim 9, wherein the connecting part (16) surrounds the housing body (18) in an angular range that is greater than 180°.

11. The solenoid according to one of claims 1 through 10, wherein the connecting part (16) is preferably made of an elastic plastic.

12. The solenoid according to claim 6 or 7, wherein the connecting part (16) is injection-molded onto the first plastic web (15).

13. The solenoid according to claim 12, wherein extensions (13) of the at least two contact tabs (10) are bent at an angle.

14. A method for connecting a solenoid (2) to at least one contact element (9), the solenoid being made of an insulating material, and having a largely cylindrical, hollow bobbin (3), which may be slid onto a housing body (18) and is provided with at least two relay connectors (1) that are anchored in an end area (4) of the bobbin (3) and project axially from it; the method having the following method steps:
mounting of the solenoid (2) on the housing body (18);
mounting of a connecting part (16) attached to the contact element (9), on the housing body (18); and
connection of the contact element (9) to the relay connectors (1) by bonding (20).

15. The method according to claim 14, wherein the relay connectors (1) of the solenoid (2) are bent at a predetermined angle.

16. The method according to claim 15, wherein the contact tabs (10) of the contact element (9) are bent toward the connecting part (16) at a predetermined angle.

17. The method according to claim 16, wherein a web (12) extending between the contact tabs (10) of the contact element (9) is punched out.
